(19) United States
(12) Patent Application Publication
(10) Pub. No.: US 2007/0287103 A1
(43) Pub. Date: Dec. 13, 2007

(54) METHOD AND APPARATUS FOR FABRICATING FLAT PANEL DISPLAYS EMPLOYING PARTIALLY TRANSPARENT BORDERS

(75) Inventors: Arie GLAZER, Mevaseret (IL); David Bochner, Ramat Gan (IL); Gershon Miller, Rehovot (IL); Ofer Saphier, Rehovot (IL); Mannie Dorfan, Nes Ziona (IL)

Correspondence Address: SUGHRUE MION, PLLC, 2100 Pennsylvania Avenue, N.W., Washington, DC, 20037, US

(73) Assignee: ORBOTECH LTD., Yavne (IL)

(21) Appl. No.: 11/618,209

(22) Filed: Dec. 29, 2006

Related U.S. Application Data
(62) Division of application No. 11/586,729, filed on Oct. 26, 2006.
(60) Provisional application No. 60/811,787, filed on Jun. 8, 2006.

(51) Int. Cl. G02B 5/20

(52) U.S. Cl. 430/321; 347/107; 347/2

(57) ABSTRACT

A method of manufacturing includes depositing a material on a surface of a substrate in a liquid form using an inkjet process, whereby the material dries in an initial shape on the substrate. A photolithographic process is applied using a mask that is separate from the substrate in order to modify the initial shape.

### CROSS-REFERENCE TO RELATED APPLICATION

This is a divisional of application Ser. No. 11/586,729 filed Oct. 26, 2006 which claims the benefit of U.S. Provisional Patent Application 60/811,787, filed Jun. 8, 2006, which are both incorporated herein by reference.

### FIELD OF THE INVENTION

The present invention relates generally to inkjet printing, and specifically to production of flat panel displays and other devices using inkjet technology

### BACKGROUND OF THE INVENTION

To produce a color flat panel display, a matrix of light-modulating elements, such as a liquid crystal display (LCD), is overlaid by a corresponding matrix of color elements. Each color element filters the light that passes through the corresponding light-modulating element and thus enables the display to present color images. Inkjet printing techniques may be used to deposit color elements on a flat panel display.

### SUMMARY OF INVENTION

Embodiments of the present invention provide methods and systems for manufacturing, which may be used, inter alia, in producing flat panel displays. An inkjet process is applied to deposit a material on a surface of a substrate in a liquid form. The material dries in an initial shape on the substrate.

In some embodiments, a photolithographic process is then applied in order to modify the initial shape, using a photolithographic mask that is separate from the substrate. Various sorts of shape modifications can be engendered using such methods. For example, in some embodiments, the photolithographic process is used to remove excess coloring material from color elements in a flat panel display. Additionally or alternatively, the photolithographic process may be used to create contact holes, as well as other finely-etched structures, extending through the coloring material to underlying layers. The use of a separate photolithographic mask affords flexibility and versatility in choosing and applying the desired shape modification. The separate mask can be used to irradiate the substrate from the front side, on which the material is deposited, and is therefore applicable to various flat panel display technologies, including color filter on array (COA), in which filter elements are printed over corresponding circuit elements on the same substrate.

In some embodiments of the present invention, the color elements are defined by borders, which are formed on the substrate prior to the inkjet process. Typically, the borders are formed from a photosensitive polymer, such as a resin, which is cured by exposure to radiation. The resin may contain a black pigment, thus forming a “black matrix,” as is known in the art. Alternatively, the polymer may be semi-transparent (clear or colored), so that the curing radiation passes through a greater thickness of the polymer. As a result, the borders may be made relatively higher and thus enable a greater quantity of ink to be deposited in each color element, with reduced spillover from one color element to another.

In other embodiments of the present invention, the color elements are created by the inkjet process without prior formation of borders on the substrate. Rather, the inkjet process is applied to create a first set of the color elements, with recesses intervening between them. After the ink in this first set of color elements has dried, the inkjet process is again applied to create the remaining color elements in the recesses. This approach reduces the number of process steps needed to create the array of color elements. Optionally, a photolithographic step may be used to remove excess ink that has flowed into the recesses from the color elements in the first set, before creating the remaining color elements in the recesses.

There is therefore provided, in accordance with an embodiment of the present invention, a method of manufacturing, including:

depositing a material on a surface of a substrate in a liquid form using an inkjet process, whereby the material dries in an initial shape on the substrate; and

applying a photolithographic process using a mask that is separate from the substrate in order to modify the initial shape.

In some embodiments, depositing the material includes creating filter elements of multiple, different colors so as to serve as a filter overlay for a flat panel display. In one of these embodiments, creating the filter elements includes depositing the material over an array of thin-film circuit elements that are formed on the substrate. Applying the photolithographic process may include opening contact holes through the filter elements, and depositing a conductive material in the contact holes so as to contact the circuit elements under the filter elements. Optionally, the method may include coating an overcoat layer over the filter elements, wherein opening the contact holes includes opening the contact holes through both the overcoat layer and the filter elements under the overcoat layer using a single photolithographic step.

In some embodiments, depositing the material includes creating elevated borders on the substrate surrounding and defining recesses into which the material is to be deposited, and ejecting the material into the recesses. Typically, creating the elevated borders includes coating a polymer material onto the substrate, and shaping the polymer material to create the borders. In one embodiment, the polymer material is at least partially transparent. Additionally or alternatively, applying the photolithographic process includes removing a portion of the material that has overflowed onto the borders.

In other embodiments, depositing the material includes depositing at least a first material so as to create a plurality of color elements on the substrate, with recesses intervening between the color elements, and applying the photolithographic process includes removing a portion of the material that has overflowed predetermined borders between the color elements and the intervening recesses, and the method includes depositing at least a second material in the recesses. In one embodiment, depositing at least the first and second materials includes creating filter elements of multiple, different colors so as to serve as a filter overlay for a flat panel display. Additionally or alternatively, depositing at least the first material includes creating multiple, parallel columns of the color elements, wherein the recesses intervene between the columns.

In a disclosed embodiment, applying the photolithographic process includes shaping the material to define an array of non-rectangular shapes on the substrate.

Typically, the material is deposited on a front side of the substrate, and applying the photolithographic process includes irradiating the substrate from the front side.

There is also provided, in accordance with an embodiment of the present invention, apparatus for manufacturing, including:

a printing station, which is arranged to deposit a material on a surface of a substrate in a liquid form using an inkjet process, whereby the material dries in an initial shape on the substrate; and

a photolithography station, which is arranged to apply a photolithographic process to the material on the substrate using a mask that is separate from the substrate in order to modify the initial shape.

There is additionally provided, in accordance with an embodiment of the present invention, a method for manufacturing a liquid crystal display (LCD), the method including:

creating elevated borders, which are at least partially transparent, on a surface of a substrate so as to surround and define a matrix of recesses on the surface;

depositing materials in the recesses so as to create filter elements of multiple, different colors for corresponding circuit elements of the LCD; and

electrically coupling a liquid crystal material to the circuit elements.

In a disclosed embodiment, creating the elevated borders includes coating a polymer material, which is at least partially transparent, onto the substrate, and applying a photolithographic process to the polymer material on the substrate in order to create the borders.

In one embodiment, the polymer material includes a colored pigment. Alternatively, the polymer material is clear.

Typically, depositing the materials includes ejecting the materials into the recesses in a liquid form using an inkjet process. Additionally or alternatively, the method includes, after depositing the materials, applying a photolithographic process to remove a portion of the materials that have overflowed onto the borders.

There is further provided, in accordance with an embodiment of the present invention, apparatus for manufacturing a liquid crystal display (LCD), the apparatus including:

a first processing station, which is arranged to create elevated borders, which are at least partially transparent, on a surface of a substrate so as to surround and define a matrix of recesses on the surface;

a second processing station, which is arranged to deposit materials in the recesses so as to create filter elements of multiple, different colors for corresponding circuit elements of the LCD; and

a third processing station, which is arranged to electrically couple a liquid crystal material to the circuit elements.

There is moreover provided, in accordance with an embodiment of the present invention, a method of manufacturing, including:

depositing at least a first material in a liquid form using an inkjet process so as to create a plurality of first color elements on the substrate, with recesses intervening between the first color elements; and

after the first color elements have dried, applying at least a second material in the recesses using the inkjet process so as to create second color elements between the first color elements.

In a disclosed embodiment, depositing at least the first and second materials includes creating filter elements of multiple, different colors so as to serve as a filter overlay for a flat panel display. Additionally or alternatively, depositing at least the first material includes creating multiple, parallel columns of the first color elements, wherein the recesses intervene between the columns.

There is furthermore provided, in accordance with an embodiment of the present invention, apparatus for manufacturing, including an inkjet printer, which is arranged to deposit at least a first material in a liquid form using an inkjet process so as to create a plurality of first color elements on the substrate, with recesses intervening between the first color elements, and which is arranged, after the first color elements have dried, to apply at least a second material in the recesses using the inkjet process so as to create second color elements between the first color elements.

The present invention will be more fully understood from the following detailed description of the embodiments thereof, taken together with the drawings in which:

### BRIEF DESCRIPTION OF DRAWINGS

The present invention will be understood and appreciated more fully from the following detailed description, taken in conjunction with the drawings in which:

FIG. 1 is a schematic, pictorial illustration of a system for manufacturing a flat panel display, in accordance with an embodiment of the present invention;

FIGS. 2A, 2B and 2C are schematic top views of matrices of color elements that are formed on flat panel displays, in accordance with embodiments of the present invention;

FIG. 3 is a flow chart that schematically illustrates a method for manufacturing a flat panel display, in accordance with an embodiment of the present invention;

FIGS. 4A-4G are schematic, sectional views showing details of a flat panel display in successive stages of manufacture, in accordance with the embodiment of FIG. 3;

FIG. 5 is a flow chart that schematically illustrates a method for manufacturing a flat panel display, in accordance with another embodiment of the present invention;

FIGS. 6A-6G are schematic, sectional views showing details of a flat panel display in successive stages of manufacture, in accordance with the embodiment of FIG. 5;

FIG. 7 is a flow chart that schematically illustrates a method for manufacturing a flat panel display, in accordance with yet another embodiment of the present invention;

FIGS. 8A-8D are schematic, sectional views showing details of a flat panel display in successive stages of manufacture, in accordance with the embodiment of FIG. 7; and

FIGS. 9A-9C are schematic, sectional views showing details of a flat panel display in successive stages of manufacture, in accordance with still another embodiment of the present invention.

### DETAILED DESCRIPTION OF PREFERRED EMBODIMENTS

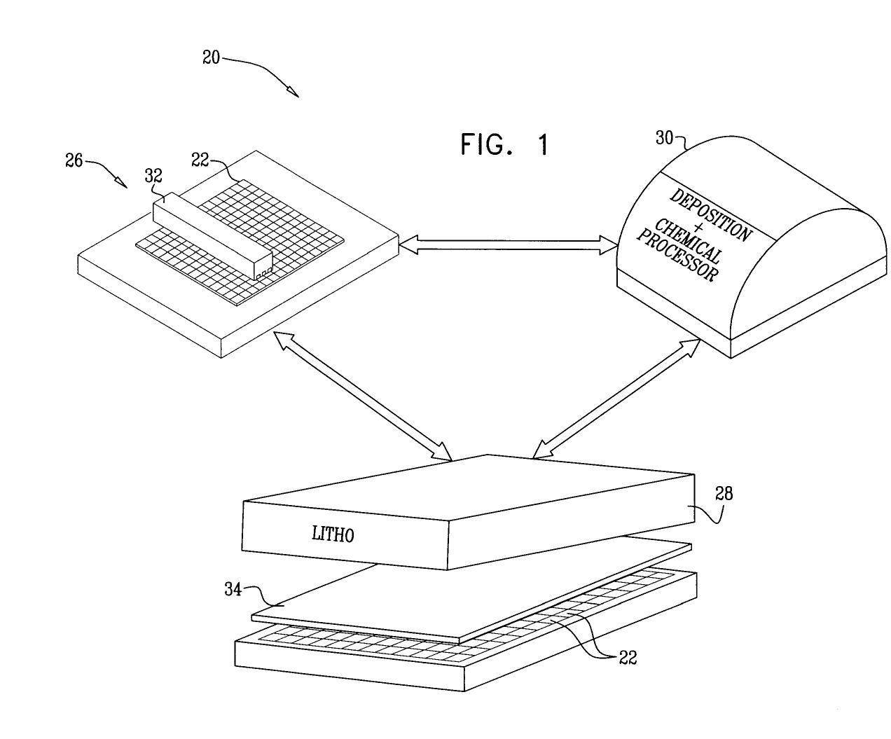

FIG. 1 is a schematic, pictorial illustration showing a system 20 for producing a flat panel display 22, in accordance with an embodiment of the present invention. The system comprises several stations: an inkjet printing station 26, a photolithography station 28, and a deposition and chemical processing station 30. Station 30 performs multiple functions, as described hereinbelow, which may in practice be divided among multiple different stations in the actual production facility. The equipment required for each of these functions will be apparent to those skilled in the art.

Inkjet printing station 26 comprises a printhead assembly 32, with multiple inkjet nozzles, which are configured to eject colored inks onto display 22, as shown in the figures that follow and described in detail hereinbelow. The printhead assembly is scanned over a substrate in order to print a matrix of color filter elements for use in display 22. Typically, the substrate for the color filter elements is a transparent plate, such as a sheet of glass. In some embodiments, the substrate with filter elements is overlaid on an array of display circuit elements after production, whereas in other embodiments, the color filter elements are printed over the circuit elements on the same substrate. Embodiments of both types are described hereinbelow. Inkjet printing stations suitable for these purposes are described, for example, in U.S. Pat. No. 6,645,029 and in U.S. patent application Ser. No. 11/472,551, filed Jun. 22, 2006, whose disclosures are incorporated herein by reference.

Lithography station 28 projects radiation, such as ultraviolet light, through a mask 34 onto display 22. The mask is separate from the display substrate and defines shapes of features that are to be formed on the substrate. For example, the mask may define the desired outlines of the color filter elements, and possibly locations of contact holes and/or other structures to be formed in the color elements. The inks that are printed by station 26 typically comprise a photosensitive polymer, such as a photosensitive resin. Therefore, the radiation projected by station 28 causes a portion of the material on the substrate to undergo chemical transformation, following which the undesired material is removed by a chemical process in station 30.

These processes may be used to remove excess ink that overflowed the boundaries of the color filter elements during printing in station 26, as well as to form contact holes and other features in the color filter elements. Exemplary implementations of these processes are described hereinbelow. Additionally or alternatively, the photolithographic and chemical processes described herein may be used to clean up ink deposited outside the display area. Examples of ink components that may be removed in this manner include:

Test patterns printed on the panel substrate.

Ink ejected from the inkjet nozzles outside the display area for purposes of cleaning the nozzles (known as “spitting”) or idling between scans.

Ink printed outside the display area so that the color elements at the display borders have the same neighboring color environment as the color elements inside the display area.

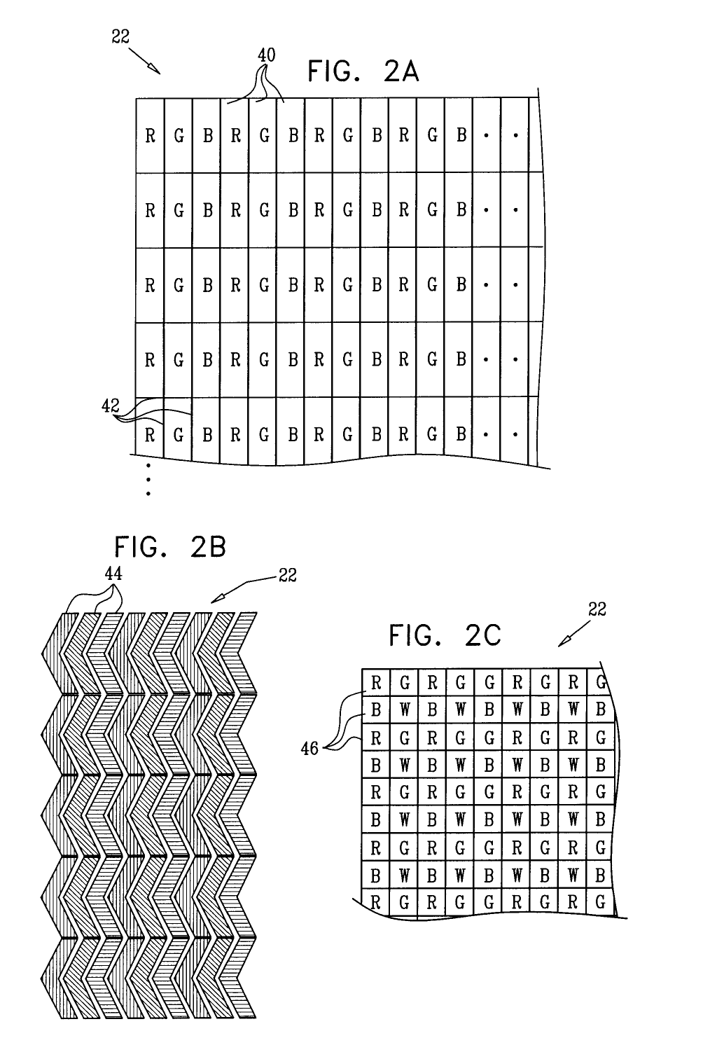

FIGS. 2A and 2B are schematic detail views of matrices of color filter elements 40 and 44, respectively, which may be printed on display 22, in accordance with embodiments of the present invention. The color filter elements in this exemplary embodiment are arranged in columns of red, green and blue, as is common in color filter matrices that are used with flat panel displays. Whereas filter elements 40 in FIG. 2A are rectangular, the color elements may have substantially any suitable polygonal shape, such as the “zigzag” or “boomerang” shape of elements 44 in FIG. 2B.

The color filter elements may be separated from their neighbors by borders 42, which are commonly referred to as a “black matrix.” These borders are deposited on substrate 22 and protrude slightly above the substrate surface, thus defining recesses into which the ink is injected by printing station 26. Alternatively, the apparatus and methods described herein may be used in depositing color filter elements that are predefined geometrically in the program of station 26 without reliance on borders of this sort.

FIG. 2C is a schematic detail view of a matrix of color filter elements 46, which may be printed on display 22 in accordance with an alternative embodiment of the present invention. In this embodiment, the columns do not all contain elements of the same color, but rather elements of alternating colors. In the example shown in the figure, the odd columns contain alternating red and blue elements, while the even columns contain alternating green and clear elements (referred to as “white” elements, containing clear polymer). Although the embodiments described hereinbelow relate mainly to patterns in which each column contains elements of a single color, the techniques of the present invention may similarly be applied, mutatis mutandis, to patterns such as that shown in FIG. 2C or to substantially any other pattern of color elements.

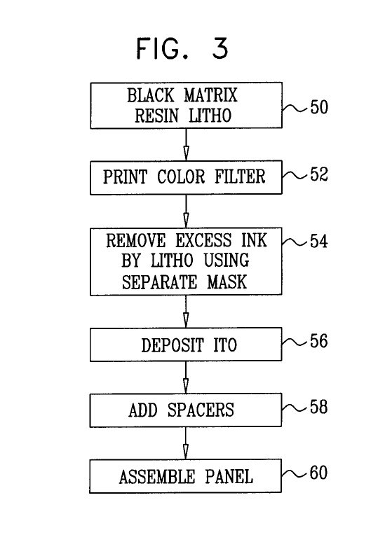

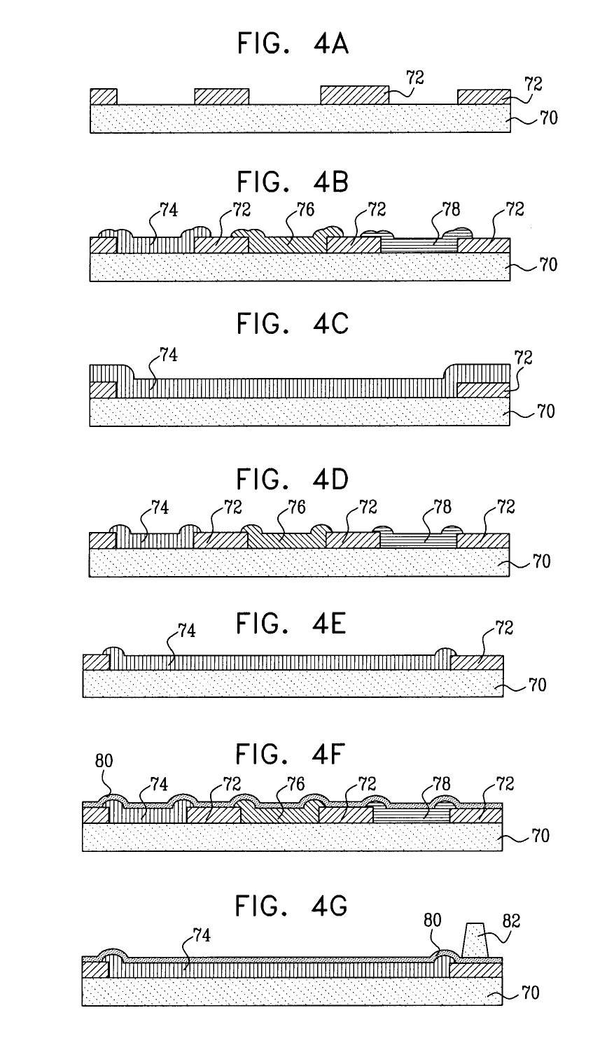

Reference is now made to FIGS. 3 and FIGS. 4A-4G, which schematically illustrate a process for manufacturing a flat panel display, in accordance with an embodiment of the present invention. In this embodiment, red filter elements 74, green filter elements 76, and blue filter elements 78 are formed on a transparent substrate 70, such as a glass plate, which is then overlaid on the display circuit array. FIG. 3 is a flow chart showing steps in the process, while FIGS. 4A-4G are sectional detail views showing the substrate, filter elements and other structures at successive stages in the process.

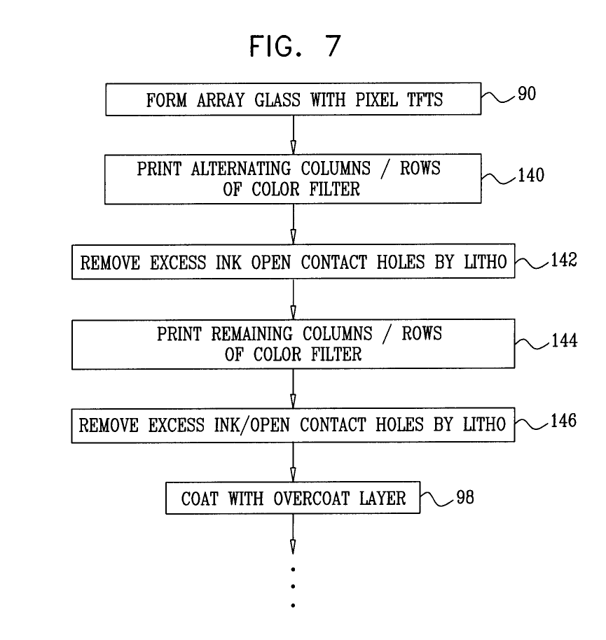

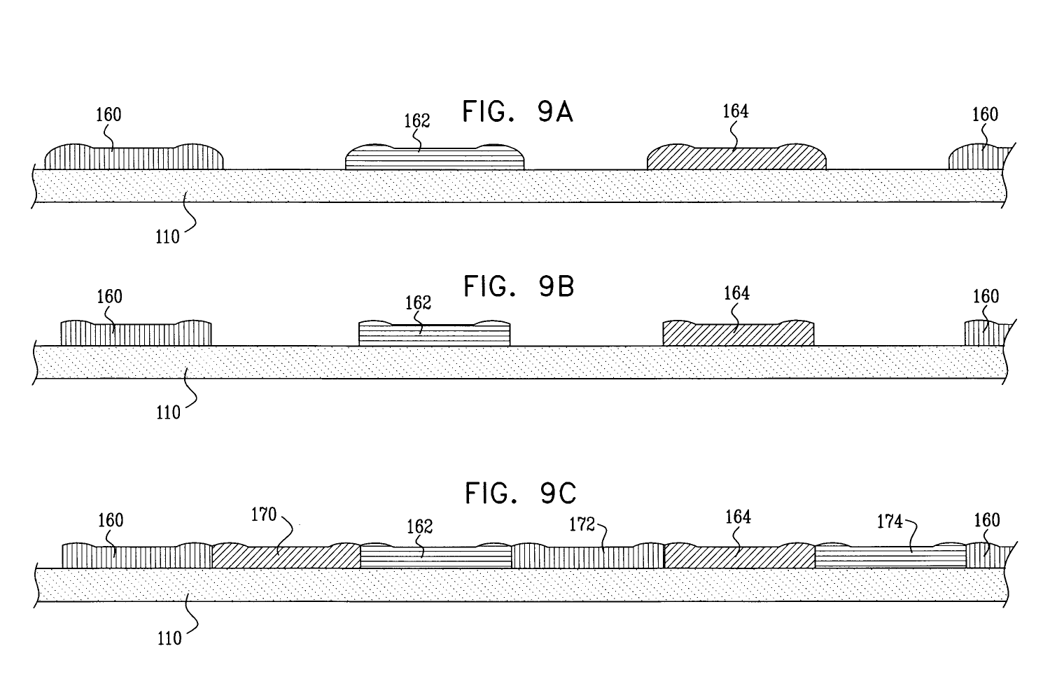

The process of FIG. 3 begins with formation of a black matrix 72 (corresponding to borders 42 in FIG. 2) on substrate 70, at a matrix deposition step 50. The borders typically comprise a suitable polymer containing black pigment, such as PSK™2000 black matrix resin, distributed by Brewer Science (Rolla, Mo.), which is coated onto the substrate and then shaped by a lithographic process, as is known in the art. The positioning of the black matrix borders is shown in FIG. 4A. Alternatively, the color filter elements may be printed without pre-deposited borders, as described below in reference to FIG. 7 or FIG. 9, for example.

Substrate 70 is now transferred to printing station 26. Filter elements 74, 76 and 78 are printed on the substrate by ejecting droplets of ink from the nozzles in printhead assembly 32, onto the appropriate locations between the borders of black matrix 72, at a filter printing step 52. The result of this step is shown in FIGS. 4B and 4C. FIG. 4B is a cross-section taken along a horizontal row in the view of FIG. 2, showing the filter elements 74, 76, 78 in successive columns of different colors. FIG. 4C is a cross-section taken along a vertical column, showing only a single red element 74. (In this example, the filter elements have a high vertical/horizontal aspect ratio.) Typically, the inks used at step 52 comprise a photosensitive component, which undergoes chemical transformation upon exposure to ultraviolet light used subsequently in the photolithography steps described below. After the ink has dried, it is typically soft-baked at low temperature so that it maintains its shape during the succeeding process steps. Because of inherent imprecision in the inkjet printing process, a certain amount of excess ink typically overflows onto black matrix 72 from each of the neighboring filter elements.

The excess ink is removed using a photolithographic process with a separate mask, at a filter shaping step 54. Substrate 70 with the printed, soft-baked filter elements is transferred to photolithography station 28. The filter elements are exposed to ultraviolet light that is projected through a mask containing the outlines of the filter elements. The outlines of the filter elements in the mask may be rectangular, as shown in FIG. 2A, or they may alternatively be designed to impart any other desired shape to the filter elements, such as the boomerang shape shown in FIG. 2B. In one embodiment, the ultraviolet light projected through the mask hardens only the portion of the ink that is within the mask outlines, while excess ink on the black matrix borders is not exposed. Alternatively, the ultraviolet light projected through the mask exposes the excess portions of the ink which is rendered thereby available to be removed. Subsequent chemical development in station 30 washes away the unhardened, excess ink without substantial effect on the filter elements themselves. As a result of this step, black matrix 72 between the color filter elements is once again exposed, as shown in FIGS. 4D and 4E (in row and column views, respectively, as in FIGS. 4B and 4C). Typically, the ink remaining after development is then hard-baked.

In an alternative embodiment (not shown in the figures), the red, green and blue filter elements are printed on substrate 70 in the form of stripes, without separation between filter elements within each column. In such cases, the black matrix typically comprises only unidirectional borders between the stripes, as well. Filter shaping step 54 may still be used, if necessary, to remove excess ink from these vertical borders. Alternatively, the method described below with reference to FIG. 7 or FIG. 9 can be used to create the stripes without use of a black matrix or bank matrix.

A transparent, indium tin oxide (ITO) coating is deposited over the surface of filter elements 74, 76, 78 and black matrix 72, at an ITO deposition step 56. A physical vapor deposition (PVD) process may be used for this purpose. As a result, the surface is covered by a thin layer 80 of ITO, as shown in FIG. 4F. Photo-spacers 82 are then formed at multiple locations on black matrix 72, at a spacer formation step 58. The result of this step is shown in FIG. 4G. The spacers typically comprise a suitable resin material, which is deposited over the ITO layer and is then shaped by a photolithographic process.

Display 22 is assembled by fixing substrate 70 to the driver circuit array (not shown), at a panel assembly step 60. Each color filter element is aligned with a corresponding driver circuit, while spacers 82 create a gap between the filter element and the driver circuit that is filled with liquid crystal material. ITO layer 80 is connected as a common electrode, opposite the individual driver electrodes of the driver circuits.

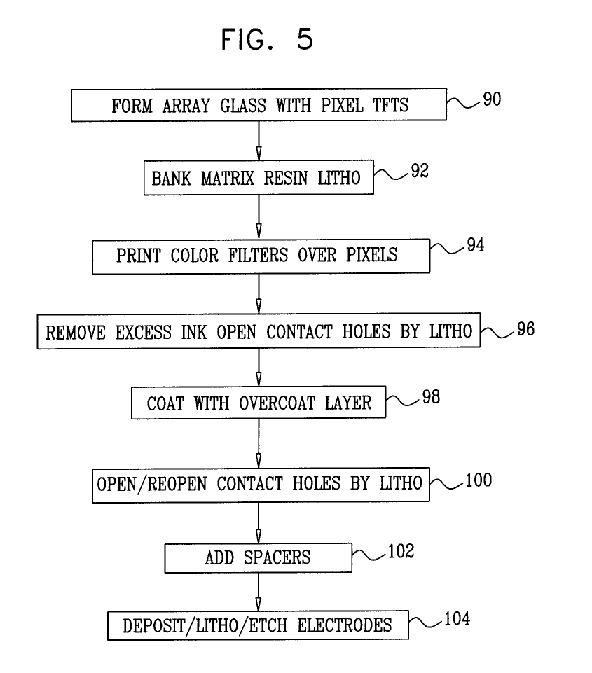

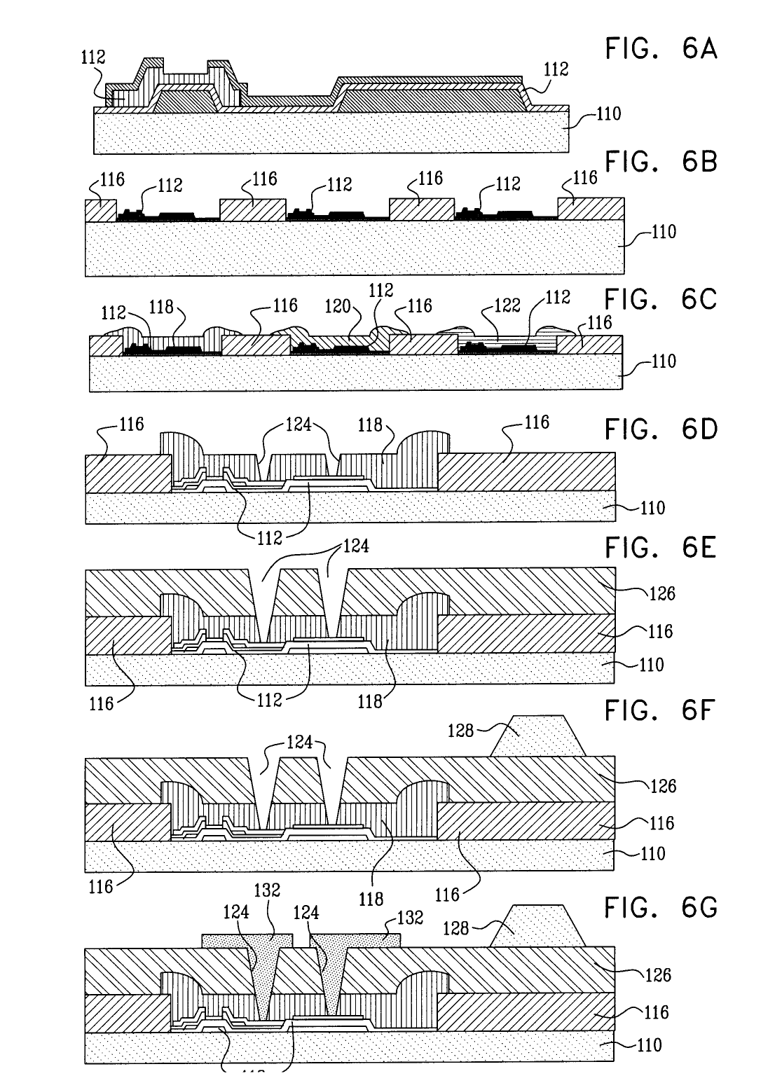

Reference is now made to FIGS. 5 and FIGS. 6A-6G, which schematically illustrate a process for manufacturing a flat panel display, in accordance with another embodiment of the present invention. In this embodiment, red filter elements 118, green filter elements 120, and blue filter elements 122 are formed directly over microelectronic circuit elements 112 in the driver circuit array on a substrate 110. This sort of configuration is known as a “Color filter On Array” (COA) panel. FIG. 5 is a flow chart showing steps in the process, while FIGS. 6A-6G are sectional detail views showing the substrate, circuit elements, filter elements and other structures at successive stages in the process.

Before depositing the filter elements, circuit elements 112 are formed on substrate 110, at an array glass formation step 90. The result of this step is shown in FIG. 6A. Circuit elements 112 typically comprise semiconductor components, such as thin-film transistors (TFTs), in each pixel of the display, while substrate 110 typically comprises glass or another suitable transparent material. (For this reason, the array of circuits is commonly referred to as an “array glass.”) Circuit elements 112 are formed using techniques known in the art, which are beyond the scope of the present patent application.

In preparation for printing of the filter elements, a “bank matrix” 116 may be formed on substrate 110, at a matrix resin lithography step 92. The bank matrix defines borders, similar to borders 42 in FIG. 2A, which create recesses (each typically containing one of the driver circuits), into which the colored inks will be subsequently deposited. Typically, the bank matrix comprises a semi-transparent resin material, which is coated over the substrate and circuit elements 112, and is then shaped using a photolithographic process to create the desired borders and recesses. The resin material may be clear, or it may alternatively be colored to prevent light of different colors from leaking through the bank matrix from neighboring pixels. The result of this step is shown in FIG. 6B. Typically, the bank matrix borders are on the order of 1.5 μm high, or higher if necessary. Since the radiation used to shape the bank matrix in the photolithographic step penetrates deeper into the semi-transparent resin coating than it could penetrate into the black resin that is used to make the black matrix, the bank matrix can be made thicker than a conventional black matrix. This sort of thicker, semi-transparent matrix between the color elements can be useful not only in conjunction with the inkjet-based processes described herein, but also in LCD panels made by other sorts of processes.

Color filter elements 118, 120 and 122 are then deposited in the recesses defined by bank matrix 116, at a filter printing step 94. The result of this step is shown in FIG. 6C. It is carried out by inkjet printing station 26 in a manner similar to step 52 (FIG. 3), as described above. In an alternative embodiment, described below with reference to FIG. 7, the color filter elements are printed without prior deposition of a bank matrix.

Following step 94, a photolithographic process similar to step 54 may be applied, if necessary, to remove excess ink that has overflowed onto bank matrix 116, at an excess removal step 96. In the same photolithography step, contact holes 124 may be opened through filter elements 118, 120, 122, as shown in FIG. 6D, to be filled subsequently with ITO for contacting the underlying circuit elements 112. Alternatively, if it is not necessary to remove excess ink, it is possible to skip step 96 and defer contact hole formation to a subsequent step in the process. This latter approach is advantageous in that it saves at least one photolithography step by comparison with the process that includes step 96.

A polymer resin overcoat layer 126 is typically coated over the color filter elements (and bank matrix), at an overcoat deposition step 98. Contact holes 124 are then opened through layer 126 using a photolithographic process, at an overcoat etching step 100. (Alternatively, this step may employ other techniques known in the art for material removal, instead of etching.) The result of this step is shown in FIG. 6E. If contact holes 124 through the filter elements were opened at step 96, then they are reopened at step 100 by removing the overlying overcoat layer. Otherwise, the contact holes are opened through both layer 126 and the underlying filter elements in a single photolithographic operation at step 100. Alternatively, if no overcoat layer is used, then steps 98 and 100 may be skipped (as long as the contact holes were formed at step 96).

Photo-spacers 128 are formed at multiple locations on bank matrix 116, at a spacer formation step 102, as shown in FIG. 6F. Step 102 uses a photolithographic process, similar to step 58, to create the spacers at the desired locations. If the resin material used to make the spacers covers contact holes 124, the holes are reopened at step 102.

Transparent electrodes 132, typically comprising ITO, are formed to contact circuit elements 112, at an electrode formation step 104. For this purpose, a layer of ITO is deposited over the entire surface of overcoat 126 and spacers 128, filling contact holes 124 and contacting the underlying circuit elements 112. The ITO is then removed from the surface, typically by a photolithographic process, to leave the desired electrode pattern for each circuit element, as shown in FIG. 6G. To complete the assembly of display 22, a liquid crystal material is filled into the gaps between spacers 128, and is closed in place by a transparent plate, which rests on the spacers.

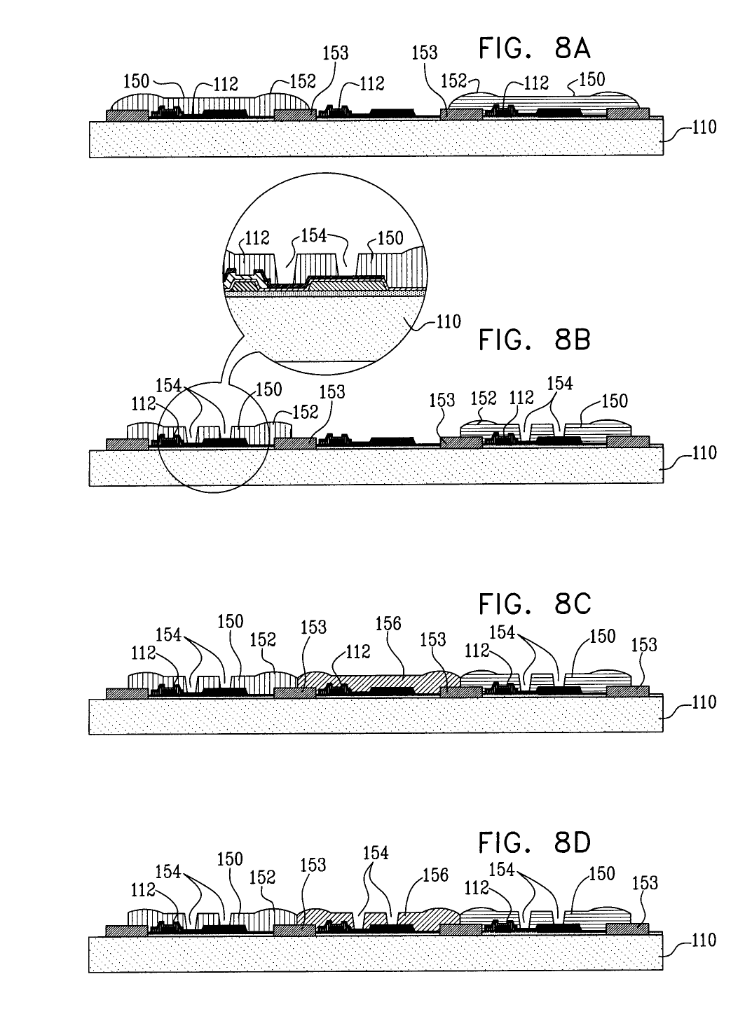

Reference is now made to FIG. 7 and FIGS. 8A-8D, which schematically illustrate a process for manufacturing a COA flat panel display, in accordance with an alternative embodiment of the present invention. FIG. 7 is a flow chart showing steps in the process, while FIGS. 8A-8D are sectional detail views showing the substrate, circuit elements, filter elements and other structures at successive stages in the process. This embodiment is similar to the method of FIG. 5, but with the distinction that no bank matrix or black matrix is used in the method of FIG. 7. Instead, after circuit elements 112 have been formed on the array glass at step 90, inkjet printing station 26 is operated to deposit ink droplets in alternating columns or rows of color filter elements 40, at an alternate printing step 140. In other words, as shown in FIG. 8A, ink of the appropriate color is ejected by printhead assembly 32 to form filter elements 150 in each of the odd-numbered vertical columns of the array, for example, while skipping over the even-numbered columns. The edges of the filter elements may overlap data lines 153 between pixels, as shown in the figure.

In the absence of a black matrix or “bank matrix,” the ink deposited on the substrate at step 140 will tend to create an overflow 152 that spills over into the adjoining, unprinted color columns. In one embodiment, a photolithographic process is applied to remove this overflow, at column straightening step 142. For example, in this step, a striped mask may be used in photolithography station 28 so that the ink in the odd-numbered columns is hardened by exposure to radiation, while the overflow ink in the area of the even-numbered columns is not. (Alternatively, other photolithographic schemes or micromachining techniques may be used to remove the excess ink.) The unhardened ink is then removed by development, leaving clean, sharp edges between the color filter elements in the odd-numbered columns and the as-yet-unprinted even-numbered columns, as shown in FIG. 8B. This same step may be used to form contact holes 154 through filter elements 150 that have been printed.

The substrate is returned to printing station 26 in order to deposit ink of the proper colors in the remaining columns of filter elements, at a print completion step 144. The ink is deposited in the recesses between the columns that were previously printed, creating filter elements 156, as shown in FIG. 8C. Some of this ink may overflow onto the neighboring columns of already-printed filter elements. This excess ink (not shown) is removed by photolithographic processing, at an excess removal step 146, during which contact holes 154 through filter elements 156 may also be etched, as shown in FIG. 8D.

The remaining steps of this method proceed as shown above in FIG. 5, starting from step 98. As these steps were described above in detail, the description will not be repeated here.

FIGS. 9A-9C are schematic, sectional views details of a flat panel display in successive stages of manufacture, in accordance with still another embodiment of the present invention. As illustrated by this embodiment, the method of printing alternating stripes using an inkjet technique, with “trimming” of the boundaries between the stripes by photolithographic or other techniques, as described above, may be used not only in COA processes, but also in printing color filter elements on other substrates. In this example, the method of FIG. 9 is adapted to print color filter elements on a plain glass plate, as used in the method of FIG. 3, without the need for prior deposition of a black matrix on the plate. Furthermore, this method is particularly suitable for creating color filters in boomerang and other non-rectangular shapes, since the ink that is deposited on the plated may be trimmed by photolithography to substantially any shape that is desired.

As shown in FIG. 9A, filter elements 160, 162, 164 of different colors are deposited by an inkjet process in alternating columns on substrate 110. The ink overflowing from the columns is removed by photolithography or another suitable process, leaving the filter elements with sharp clean edges, as shown in FIG. 9B. The inkjet process is then repeated to deposit filter elements 170, 172, 174 in the gaps between filter elements 160, 162, 164, as shown in FIG. 9C.

Although the methods described above relate mainly to patterns of color elements such as that shown in FIG. 2A, in which each column contains elements of a single, respective color, the principles of these methods may similarly be applied to patterns of other sorts, such as the pattern shown in FIG. 2C. For example, the method of FIG. 7 may be modified so that instead of printing alternating columns in the first printing step (i.e., step 140), inkjet printing station 26 prints alternating color elements 46, such as the R and W elements in FIG. 2C. The lithographic process (step 142) is applied to remove the excess ink from the square recesses interspersed between the R and W elements, leaving a checkerboard-type pattern. The recesses in the “checkerboard” are then filled with B and G ink in the second printing step (parallel to step 144).

The techniques described above for printing alternate elements (including printing alternate columns) in two separate printing steps may also be applied in conjunction with a black matrix or “bank matrix.” In other words, after the matrix of borders (black or semi-transparent) has been formed on the substrate, the first set of color elements is printed in the appropriate recesses defined by the matrix. The overflow from these elements onto the borders and the recesses between the printed elements is then removed by photolithography, after which the remaining color elements is printed in the recesses.

Moreover, although the embodiments described above relate specifically to production of LCD panels, the principles of the present invention may similarly be applied in producing flat panel displays of other types, as well as in other applications of inkjet printing technology. It will thus be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for manufacturing a liquid crystal display (LCD), the method comprising:
creating elevated borders, which are at least partially transparent, on a surface of a substrate so as to surround and define a matrix of recesses on the surface;
depositing materials in the recesses so as to create filter elements of multiple, different colors for corresponding circuit elements of the LCD; and
electrically coupling a liquid crystal material to the circuit elements.

2. The method according to claim 1, wherein creating the elevated borders comprises:
coating a polymer material, which is at least partially transparent, onto the substrate; and
applying a photolithographic process to the polymer material on the substrate in order to create the borders.

3. The method according to claim 1, wherein the polymer material comprises a colored pigment.

4. The method according to claim 1, wherein the polymer material is clear.

5. The method according to claim 1, wherein depositing the materials comprises ejecting the materials into the recesses in a liquid form using an inkjet process.

6. The method according to claim 1, and comprising, after depositing the materials, applying a photolithographic process to remove a portion of the materials that have overflowed onto the borders.

7. Apparatus for manufacturing a liquid crystal display (LCD), the apparatus comprising:
a first processing station, which is arranged to create elevated borders, which are at least partially transparent, on a surface of a substrate so as to surround and define a matrix of recesses on the surface;
a second processing station, which is arranged to deposit materials in the recesses so as to create filter elements of multiple, different colors for corresponding circuit elements of the LCD; and
a third processing station, which is arranged to electrically couple a liquid crystal material to the circuit elements.

8. The apparatus according to claim 7, wherein the substrate is coated with a polymer material that is at least partially transparent, and wherein the first processing station comprises a photolithography station, which is arranged to apply photolithographic process to the polymer material on the substrate in order to create the borders.

9. The apparatus according to claim 7, wherein the polymer material comprises a colored pigment.

10. The apparatus according to claim 7, wherein the polymer material is clear.

11. The apparatus according to claim 7, wherein the second processing station is arranged to eject the materials into the recesses in a liquid form using an inkjet process.

12. The apparatus according to claim 7, and comprising a photolithography station, which is arranged, after deposition of the materials in the recesses, to apply a photolithographic process in order to remove a portion of the materials that have overflowed onto the borders.
